(19) United States
(12) Patent Application Publication
(10) Pub. No.: US 2007/0028161 A1
(43) Pub. Date: Feb. 1, 2007

(54) Displaying text in variable width display fields

(76) Inventors: Julianne F. Haugh, Austin, TX (US); Shiva Persaud-Deolall, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/189,936

(22) Filed: Jul. 26, 2005

(51) Int. Cl. G06F 17/24

(52) U.S. Cl. 715/508

(57) ABSTRACT

Methods, systems, and products are provided for displaying text in variable width display fields. Embodiments include receiving a plurality of lines of text for display in variable width display fields produced by a computer program; receiving field display parameters; calculating, for each line of text, the width of a plurality of display fields in dependence upon the field display parameters and the received text; determining, for each line of text, display text for display in the display fields in dependence upon the field display parameters and the received text; and visually presenting the display text in the display fields.

### BACKGROUND OF THE INVENTION

1. Field of the Invention

The field of the invention is data processing, or, more specifically, methods, systems, and products for displaying text in variable width display fields.

2. Description of Related Art

Many applications currently support displaying text in fields having fixed field widths. Such field widths often define the width of a particular column of information being displayed. Applications that currently support displaying text in fields having fixed field widths include spreadsheets, operating system functions, web pages displayed in a web browser, and so on as will occur to those of skill in the art. The text to be displayed in a field having a fixed field width may be longer than the width of the field. In such, often the text is truncated and only a portion of the text is displayed in the field. There is therefore an ongoing need for improvement in displaying text in variable width display fields.

### SUMMARY OF THE INVENTION

Methods, systems, and products are provided for displaying text in variable width display fields. Embodiments include receiving a plurality of lines of text for display in variable width display fields produced by a computer program; receiving field display parameters; calculating, for each line of text, the width of a plurality of display fields in dependence upon the field display parameters and the received text; determining, for each line of text, display text for display in the display fields in dependence upon the field display parameters and the received text; and visually presenting the display text in the display fields.

The field display parameters may include a text abbreviation parameter for a particular field. Determining, for each line of text, display text for display in the display fields in dependence upon the field display parameters may be carried out by modifying text associated with the particular field in dependence upon the text abbreviation parameter. Visually presenting the display text in the display fields may be carried out by visually presenting the modified text in the particular field.

The field display parameters may include a total line length parameter for a plurality of display fields. Calculating, for each line of text, the width of a plurality of display fields in dependence upon the field display parameters and the received text may include reducing the width of at least one field in dependence upon the total line length parameter.

The field display parameters may include a soft boundary parameter for a boundary between two display fields. Calculating, for each line of text, the width of a plurality of display fields in dependence upon the field display parameters and the received text may be carried out by increasing the width of at least one of the two display fields in dependence upon the text to be displayed in the two display fields.

The field display parameters may include a text precision parameter for a particular field. Determining, for each line of text, display text for display in the display fields in dependence upon the field display parameters may be carried out by modifying received text associated with the particular field in dependence upon the text precision parameter. Visually presenting the display text in the display fields may be carried out by visually presenting the modified text in the particular field.

The field display parameters may include a text alignment parameter for a particular field. Determining, for each line of text, display text for display in the display fields in dependence upon the field display parameters may be carried out by modifying the received text in dependence upon the text alignment parameter. Visually presenting the display text in the display fields may be carried out by visually presenting the modified received text in the particular field.

The field display parameters may include a priority parameter for a particular field. Calculating, for each line of text, the width of a plurality of display fields in dependence upon the field display parameters and the received text may be carried out by increasing the width of the particular field in dependence upon the priority parameter and the text.

The field display parameters may include a priority parameter for a particular field. Calculating, for each line of text, the width of a plurality of display fields in dependence upon the field display parameters and the received text may be carried out by decreasing the width of the particular field in dependence upon the priority parameter and the text.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system of computers each of which may have installed upon it an application for displaying text in variable width display fields according to embodiments of the present invention.

FIG. 2 sets forth a line drawing illustrating an exemplary display having text displayed according to the present invention.

FIG. 3 sets forth a block diagram of automated computing machinery comprising an exemplary computer useful in displaying text in variable width display fields according to embodiments of the present invention.

FIG. 4 sets forth a flow chart illustrating an exemplary computer implemented method for displaying text in variable width display fields according to embodiments of the present invention.

FIG. 5 sets forth a flow chart illustrating the method for displaying text in variable width display fields of FIG. 4 in which the field display parameters includes a text abbreviation parameter for a particular field.

FIG. 6 sets forth a flow chart illustrating the method for displaying text in variable width display fields of FIG. 4 in which the field display parameters includes a total line length parameter for a plurality of display fields.

FIG. 7 sets forth a flow chart illustrating the method for displaying text in variable width display fields of FIG. 4 in which a field display parameter is a soft boundary parameter for a boundary between two display fields.

FIG. 8 sets forth a flow chart illustrating the method for displaying text in variable width display fields of FIG. 4 in which a field display parameter is a text precision parameter for a particular field.

FIG. 9 sets forth a flow chart illustrating the method for displaying text in variable width display fields of FIG. 4 in which a field display parameter is a text alignment parameter for a particular field.

FIG. 10 sets forth a flow chart illustrating the method for displaying text in variable width display fields of FIG. 4 in which a field display parameter is a priority parameter for a particular field.

### DETAILED DESCRIPTION OF EXEMPLARY EMBODIMENTS

### Introduction

The present invention is described to a large extent in this specification in terms of methods for displaying text in variable width display fields. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Displaying Text in Variable Width Display Fields

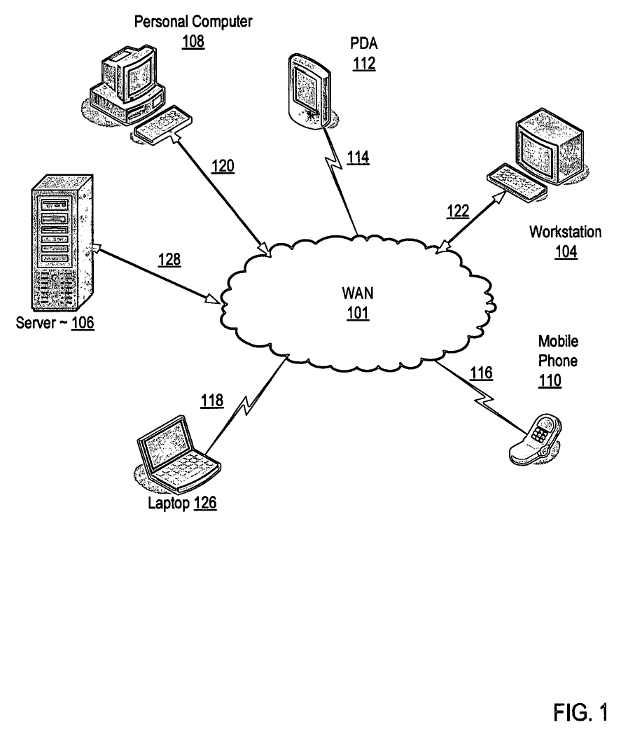

Exemplary methods, systems, and products for displaying text in variable width display fields according to embodiments of the present invention are described with reference to the accompanying drawings, beginning with FIG. 1. FIG. 1 sets forth a network diagram illustrating an exemplary system of computers each of which may have installed upon it an application for displaying text in variable width display fields according to embodiments of the present invention. The data processing system of FIG. 1 includes a wide area network (“WAN”). The network connection aspect of the architecture of FIG. 1 is only for explanation, not for limitation. In fact, systems for displaying text in variable width display fields may be connected as LANs, WANs, intranets, internets, the Internet, webs, the World Wide Web itself, or other connections as will occur to those of skill in the art. Such networks are media that may be used to provide data communications connections between various devices and computers connected together within an overall data processing system. Displaying text in variable width display fields according to embodiments of the present invention may alternatively also be implemented in a single computer without network connectivity.

In the example of FIG. 1, several exemplary devices including a PDA (112), a computer workstation (104), a mobile phone (110), a laptop (126), a server (106) and personal computer (108) are connected to the WAN (101). Network-enabled mobile phone (110) connects to the WAN (101) through a wireless link (116), the laptop (126) connects to the WAN (101) through a wireless link (118), and the PDA (112) connects to the network (101) through a wireless link (114). In the example of FIG. 1, the personal computer (108) connects to the WAN (101) through a wireline connection (120), the computer workstation (104) connects to the WAN (101) through a wireline connection (122), and the server (106) connects to the WAN (101) through a wireline (128) connection.

In the system of FIG. 1, each exemplary device (108, 112, 104, 110, and 126) has installed upon it an application capable of being modified to displaying text in variable width display fields according to embodiments of the present invention. Such applications include spreadsheets, operating system functions, web pages displayed in a web browser, and so on as will occur to those of skill in the art. All such applications may be modified, through for example a plug-in, to display text in variable width display fields according to embodiments of the present invention.

Applications that display text in variable width display according to embodiments of the present invention operate generally by receiving a plurality of lines of text for display in variable width display fields produced by a computer program; receiving field display parameters; calculating, for each line of text, the width of a plurality of display fields in dependence upon the field display parameters and the received text; determining, for each line of text, display text for display in the display fields in dependence upon the field display parameters and the received text; and visually presenting the display text in the display fields. Field display parameters are data describing display characteristics of the fields for each line in which the display text is to be displayed, as well as data describing how the received text may be modified for display in those fields. That is, field display characteristics represented in field display parameters are used for each line of text to be displayed both to determine the width of a field in which the display text is to be displayed and whether the received text to be displayed in the field is to be modified prior to being displayed. Examples of field display parameters include parameters describing whether the contents of a field are required to be displayed with a particular degree of precision, whether the contents of a field may be modified, the alignment of text within a field, whether the text to be displayed within a field is given a high priority and therefore may not be a candidate for modification, and others as will occur to those of skill in the art.

The arrangement of servers and other devices making up the exemplary system illustrated in FIG. 1 is for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

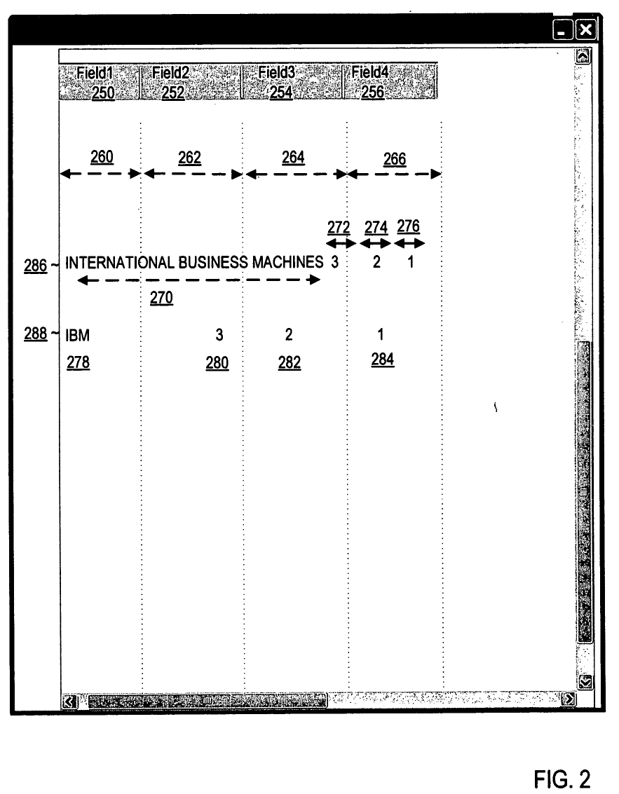

For further explanation, FIG. 2 sets forth a line drawing illustrating an exemplary display having text displayed according to the present invention. The exemplary display provides four fields for displaying text each having a default field width. Field 1 (250) has a default field width (260). Field 2 (252) has a default field width (262). Field 3 (254) has a default field width (264). Field 4 (256) has a default field width (266).

In the example of FIG. 1, a first line of text (286) is received for display and display text “International Business Machines” is produced for display in Field 1 (250), the display text “3” is produced for display in Field 2 (252), the display text “2” is produced for display in Field 3 (254) and the display text “1” is produced for display in Field 4 (256). Displaying text in variable width display fields according the example of FIG. 2 operates to calculate an increased field width (270) for Field 1 (250) for displaying the text “International Business Machines.” To accommodate increasing the field width of Field 1 (250), displaying text in variable width display according the example of FIG. 2 operates to reduce the field width (272) of Field 2 (252) for displaying the text “3,” reduce the field width (274) of Field 3 (254) for displaying the text “2,” and reduce the field width (276) of Field 4 (256) for displaying the text “1.” Displaying text in variable width display according to embodiments of the present invention provides a vehicle for accommodating longer text by increasing field widths as needed when displaying text in a plurality of fields.

In the example of FIG. 2, a second line of text (288) is received for display and the display text “IBM” is produced for display in Field 1 (250) and is left-justified in Field 1 (250), the display text “3” is produced for display in Field 2 (252) and is right justified in Field 2 (252), the display text “2” is produced for display in Field 3 (254) and is centered in Field 3 (254), and the display text “1” is produced for display in Field 4 (256) and is centered in Field 4 (256). Displaying text in variable width display fields according the example of FIG. 2 operates in the second line of text (288) left justify the text Field 1 (250), right justify the text in Field 2 (252), center the text in Field 3 (254), and center the text in Field 4 (256). In this example, the field widths of the second line of text (288) are not modified.

The example of FIG. 2 illustrates two lines of text displayed in four fields. The example of FIG. 2 is for explanation, and not for limitation. Displaying text in variable width display according to embodiments of the present invention may be carried out in a number of ways for many lines of text in any number of fields the width of which may be calculated in a many ways in accordance with the present invention and the text displayed may be determined in many ways as will occur to those of skill in the art.

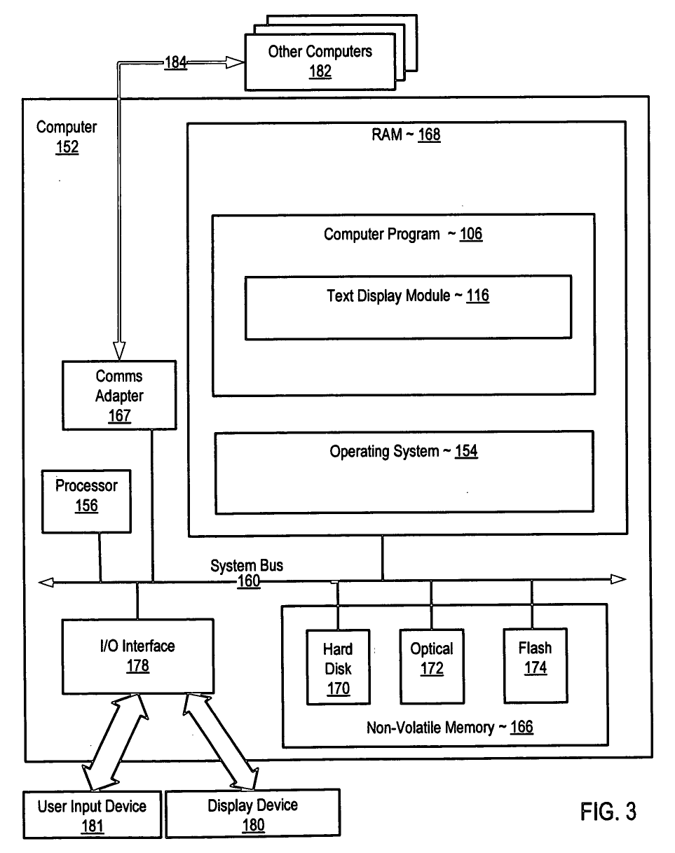

Displaying text in variable width display fields in accordance with the present invention is generally implemented with computers, that is, with automated computing machinery. In the system of FIG. 1, for example, all the nodes, servers, and communications devices are implemented to some extent at least as computers. For further explanation, therefore, FIG. 3 sets forth a block diagram of automated computing machinery comprising an exemplary computer (152) useful in displaying text in variable width display fields according to embodiments of the present invention. The computer (152) of FIG. 3 includes at least one computer processor (156) or ‘CPU’ as well as random access memory (168) (‘RAM’) which is connected through a system bus (160) to processor (156) and to other components of the computer.

Stored in RAM (168) is a computer program (106) that produces text for display in fields having field widths. Computer programs (106) that produce text for display in such fields include word processing applications, spreadsheet applications, operating system functions, and so on as will occur to those of skill in the art. The exemplary computer programs (106) that produce text for display in fields has been modified to include a text display module (116) that displays text output of the computer program (106) in variable width display fields according to embodiments of the present invention. The text display module (106) operates generally to display text in variable width display fields according to embodiments of the present invention by receiving a plurality of lines of text for display in variable width display fields produced by a computer program; receiving field display parameters; calculating, for each line of text, the width of a plurality of display fields in dependence upon the field display parameters and the received text; determining, for each line of text, display text for display in the display fields in dependence upon the field display parameters and the received text; and visually presenting the display text in the display fields.

Also stored in RAM (168) is an operating system (154). Operating systems useful in computers according to embodiments of the present invention include UNIX™, Linux™, Microsoft NT™, AIX™, IBM's i5/OS™, and others as will occur to those of skill in the art. Operating system (154), computer program (106), and text display module (116) in the example of FIG. 3 are shown in RAM (168), but many components of such software typically are stored in non-volatile memory (166) also.

Computer (152) of FIG. 3 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 3 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters include modems for wired dial-up communications, Ethernet (IEEE 802.3) adapters for wired network communications, and 802.11b adapters for wireless network communications.

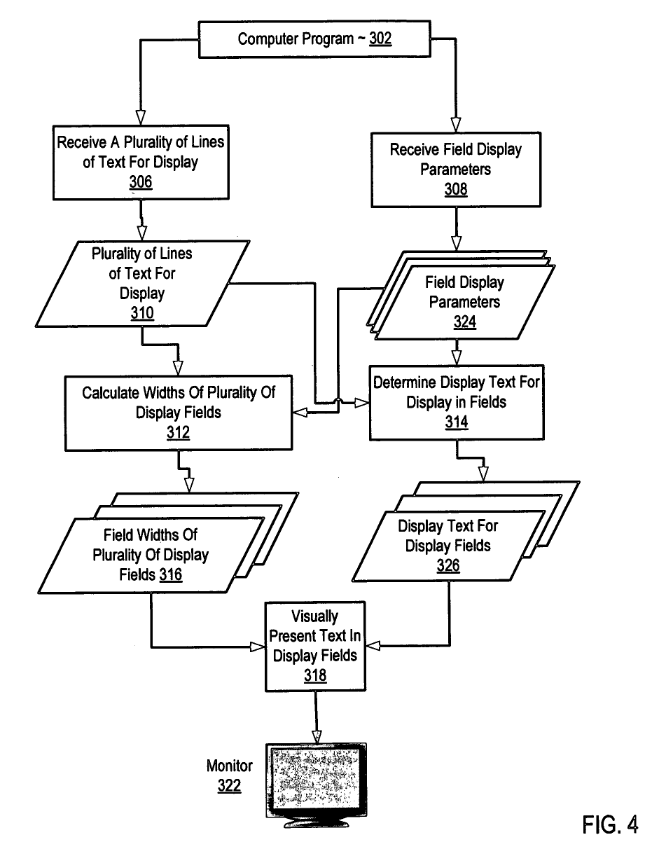

For further explanation, FIG. 4 sets forth a flow chart illustrating an exemplary computer implemented method for displaying text in variable width display fields according to embodiments of the present invention. The method of FIG. 4 includes receiving (306) a plurality of lines of text (310) for display in variable width display fields produced by a computer program (302). As discussed above, many computer programs currently support displaying text in fields that have field widths. Often these field widths define the width of columns of the display information. Examples of such computer programs include word processing applications, spreadsheet applications, operating system functions, and so on as will occur to those of skill in the art. All such computer programs are capable of modification, through for example a plug-in, to include the capability of displaying text in variable width display fields according to embodiments of the present invention.

One specific example of a computer program that produces text for display in fields that have field widths capable of modification in accordance with the present invention is the 1s function of the AIX operating system. The 1s function writes to standard output the contents of directories. The 1s function is included for explanation, not for limitation. In fact, many computer programs produce text for display in fields that have field widths.

Text for display according to the method of FIG. 4 is output from a computer program that is intended for presentation to a user. One example of text for display according to the method of FIG. 4 includes text output produced by the 1s function of the AIX operating system.

The method of FIG. 4 also includes receiving (308) field display parameters (324). Field display parameters are data describing display characteristics of the fields in which each line of the text is to be displayed, as well as data describing how each line of text may be modified for display in the those fields. That is, field display characteristics represented in field display parameters are used both to determine for each line of text the width of a field in which the text is to be displayed and whether the text to be displayed in the field is to be modified. Examples of field display parameters include parameters describing whether the contents of a field are required to be displayed with a particular degree of precision, whether the contents of a field may be modified, the alignment of text within a field, whether the text to be displayed within a field is given a high priority and therefore may not be a candidate for modification, and others as will occur to those of skill in the art.

The method of FIG. 4 includes calculating (312), for each line of text, the width of a plurality of display fields (316) in dependence upon the field display parameters (324) and the received text (310). Calculating, for each line of text, the width of a plurality of display fields (316) in dependence upon the field display parameters (324) and the received text (310) may be carried out by parsing the field display parameters and determining, in dependence upon the field display parameters and the length of the line of text or the text to be displayed in the field, a field width for displaying the text. One way of calculating (312) the width of a plurality of display fields (316) may be carried out by determining a default width of a plurality of display fields and calculating the length of the text received for display in the plurality of display fields. If the length of the text for display in a particular field is less than the default width of the field in which the text is to be displayed, then the text is displayed in the particular field without modification to the text or the default width of the field. That is, if the text for display in a particular field fits within the default width of the field, then the text is displayed without modification to either the text or the default field width. If the length of the text for display in a particular field is not less than the default width of the field, then either the text is modified in accordance with the field display parameters, such as by abbreviating the text or displaying the text with less precision, the width of the field is increased according to the field display parameters, or both the text is modified and the width of the field is increased.

In embodiments in which the default widths of one or more display fields are increased, often the increase of the width of one field while also reducing the width of another field. One way of calculating (312), for each line of text, the width of a plurality of display fields (316) in such cases may be carried out by retrieving from the field display parameters a priority for each field and reducing the width of the lower priority field and increasing the width of a higher priority field if the length of the text to be displayed in the higher priority field is greater than the default width of the high priority field.

As discussed above, displaying text in variable width display fields may include modifying the text to be displayed in a particular field. The method of FIG. 4 therefore includes determining (314), for each line of text, display text for display (326) in the fields in dependence upon the field display parameters (324) and the received text. Determining (314) display text for display (326) in the fields in dependence upon the field display parameters (324) and the received text may be carried out by modifying the text to be displayed in one or more of fields in accordance with the field display parameters. Modifying the text to be displayed in one or more fields in accordance with the field display parameters may include abbreviating the text to be displayed, truncating the text to be displayed, realigning the text to be displayed, modifying the precision of the text to be displayed, changing the text by including a shorter synonym or acronym of the text, or any other way of modifying the text for display in one or more of the fields as will occur to those of skill in the art.

Determining (314), for each line of text, display text for display (326) in the fields in dependence upon the field display parameters (324) and the received text may alternatively be carried out by identifying that the received text may be displayed in one or more of the fields without modification. Such received text is typically text whose length does not exceed the default field width of the field in which the text is to be displayed.

The method of FIG. 4 also includes visually presenting (318) the display text in the display fields. Visually presenting (318) the display text in the display fields may be carried out by displaying the display text in the display fields on visual output devices connected to a computer, such as a monitor (322), the screen of a PDA or cell phone, or other visual output devices as will occur to those of skill in the art. Visually presenting (318) the display text in the display fields may also be carried out by printing the text in the display fields, writing the text in the display fields to a static digital media or any other way of visually presenting the text in the display fields that will occur to those of skill in the art.

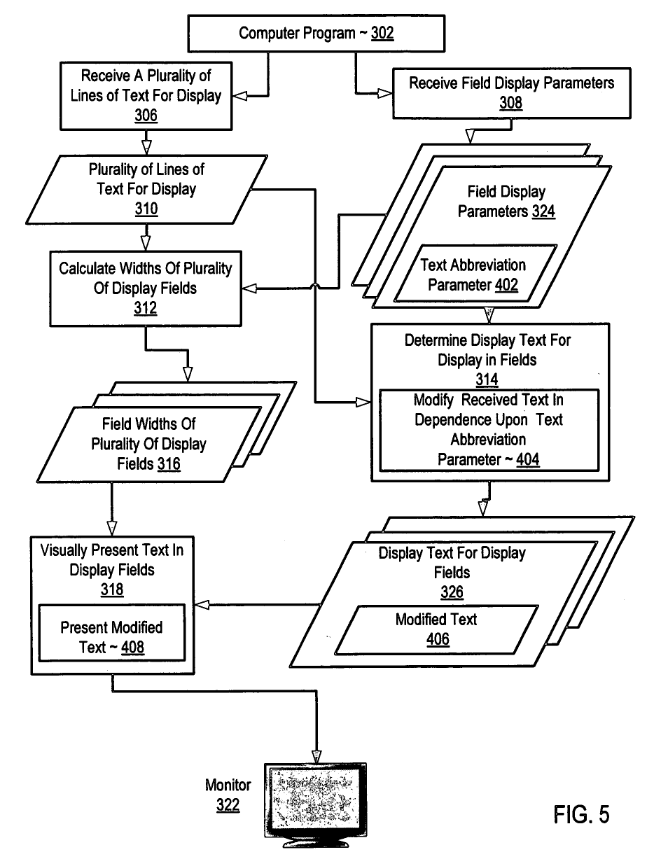

As discussed above, various field display parameters represent different characteristics used for each line of text to both to determine the width of a field in which text is to be displayed and whether the text to be displayed in the field is to be modified. For further explanation, FIG. 5 sets forth a flow chart illustrating the method for displaying text in variable width display fields of FIG. 4 in which the field display parameters includes a text abbreviation parameter (402) for a particular field. A text abbreviation parameter for a field is a display parameter that indicates that the text for the field may be abbreviated to reduce the width of the text to be displayed.

In the method of FIG. 5, determining, for each line of text, display text (314) for display in the fields in dependence upon the field display parameters and the received text includes modifying text (404) associated with the particular field in dependence upon the text abbreviation parameter (402). Modifying text (404) associated with the particular field in dependence upon the text abbreviation parameter (402) can be carried out by substituting an abbreviation of the text for the text. For example, the text “United States 2” may be substituted with the abbreviation “US 2.” Substituting an abbreviation of the text for the text may be carried out by looking up an abbreviation for the text in an abbreviations database or abbreviations list available to a computer program capable of displaying text in variable width display fields in accordance with the present invention.

In the method of FIG. 5 visually presenting the display text in the display fields includes visually presenting (408) the modified text (406) in the particular field. Visually presenting (408) the modified text (406) in the particular field may be carried out by displaying the text in the display fields on visual output devices connected to a computer, such as a monitor (322), the screen of a PDA or cell phone, or other visual output devices as will occur to those of skill in the art. Visually presenting (408) the modified text (406) in the particular field may also be carried out by printing the text in the display fields, writing the text in the display fields to a static digital media or any other way of visually presenting the text in the display fields that will occur to those of skill in the art.

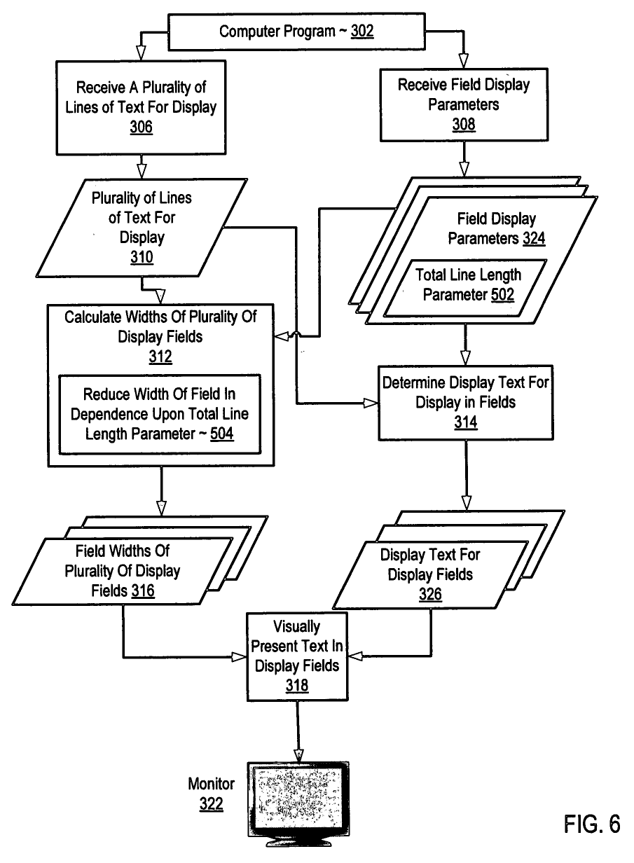

As discussed above, various field display parameters represent different characteristics used for each line of text both to determine the width of a field in which the text is to be displayed and whether the text to be displayed in the field is to be modified. For further explanation, FIG. 6 sets forth a flow chart illustrating the method for displaying text in variable width display fields of FIG. 4 in which the field display parameters includes a total line length parameter (502) for multiple display fields. A total line length parameter specifies the maximum width for the display of the multiple display fields.

In the method of FIG. 6, calculating (312), for each line of text, the width (316) of a plurality of display fields in dependence upon the field display parameters (324) and the received text (310) includes reducing (504) the width of at least one field in dependence upon the total line length parameter (502). Reducing (504) the width of at least one field in dependence upon the total line length parameter (502) may be carried out by shifting boundaries between display fields to reduce the width of one or more fields such that the total line length of the fields does not exceed the total line length.

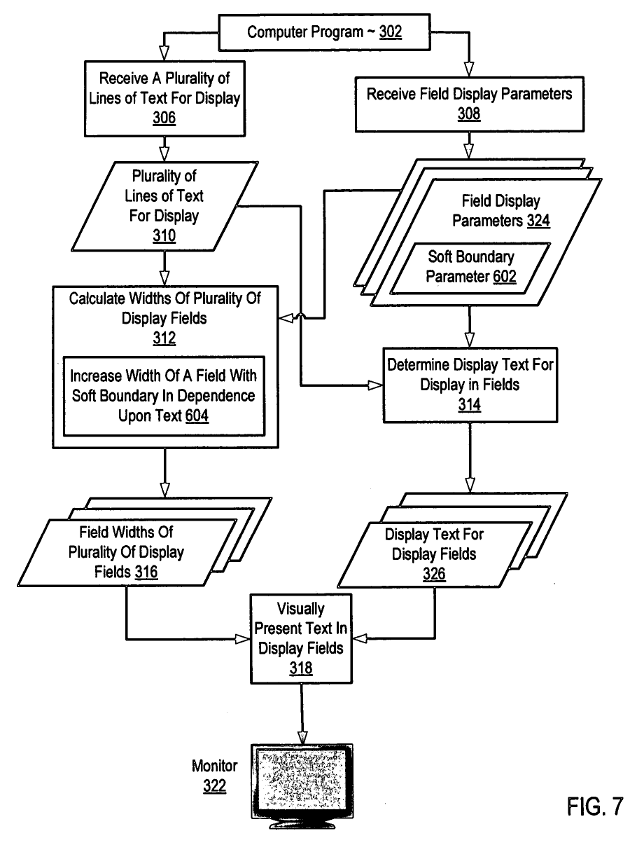

As discussed above, various field display parameters represent different characteristics used both to determine the width of a field in which text is to be displayed and whether the text to be displayed in the field is to be modified. For further explanation, FIG. 7 sets forth a flow chart illustrating the method for displaying text in variable width display fields of FIG. 4 in which a field display parameter is a soft boundary parameter (602) for a boundary between two display fields. A ‘soft boundary’ defines a boundary between two display fields that can be moved left or right to expand the width of one of the adjoining fields, allowing the expanded field to accommodate a text whose length is longer than the previous default width of the field. Expanding one field typically occurs at the expense of another field. That is, expanding one field typically requires the width of another field to be reduced.

In the method of FIG. 7, calculating (312), for each line of text, the width (316) of a plurality of display fields in dependence upon the field display parameters (324) and the received text (310) includes increasing (604) the width of at least one of the two display fields in dependence upon the text (310) to be displayed in the two display fields. Increasing the width of at least one of the two display fields in dependence upon the text may be carried out by shifting the soft boundary to increase the width of one of the adjoining fields.

Consider the following example of calculating (312), for each line of text, the width (316) of a plurality of display fields in dependence upon the field display parameters (324) and the received text (310) by increasing (604) the width of at least one of the two display fields. The following is an exemplary soft boundary (602) describing a soft boundary between two fields each three characters wide:

<3 chars> <soft boundary, width=1> <3 chars>

The element ‘<3 chars>’ indicates that the first field is three characters wide. The element ‘<soft boundary, width=1>’ indicates that a soft boundary lies to the right of the first field. The element ‘<3 chars>’ indicates that the second field is three characters wide.

Displaying ‘this’ in the first field and ‘is’ in the second field without increasing the width the first field according to the method of FIG. 7 results in the following display: ‘thi is.’ Increasing the width the first field by one character according to the method of FIG. 7 creates a first field that is four characters wide and a second field that is two characters wide and results in the following display: ‘this is’

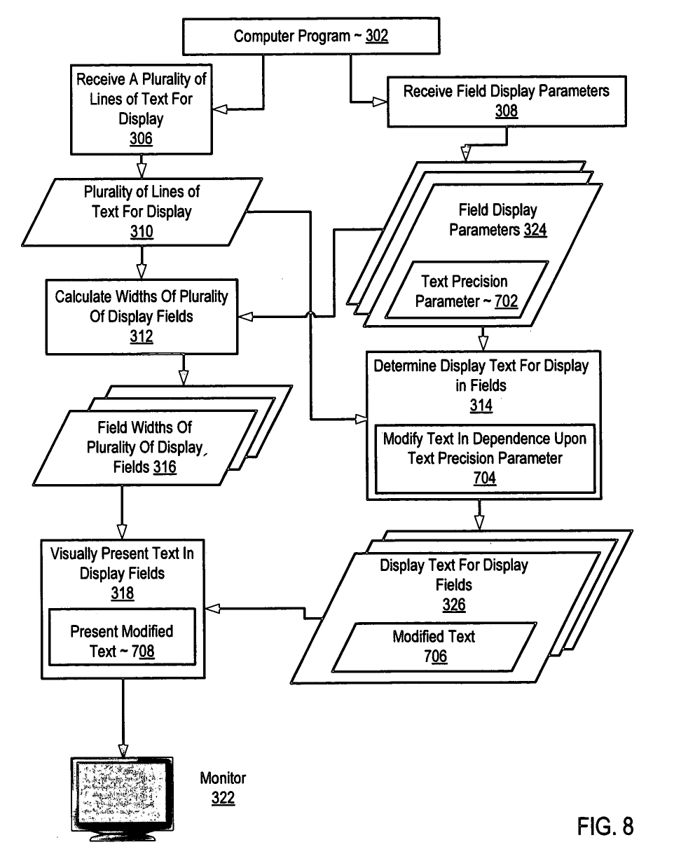

As discussed above, various field display parameters represent different characteristics used for each line of text both to determine the width of a field in which text is to be displayed and whether the text to be displayed in the field is to be modified. For further explanation, FIG. 8 sets forth a flow chart illustrating the method for displaying text in variable width display fields of FIG. 4 in which a field display parameter is a text precision parameter (702) for a particular field. A text precision parameter identifies that numerical text may be modified by displaying the text with less precision. In some cases the text precision parameter may also identify a specific technique for reducing the width of a field by displaying a number with less precision.

In the method of FIG. 8, determining (314), for each line of text, display text for display in the display fields in dependence upon the field display parameters includes modifying (704) the received text associated with the particular field in dependence upon the text precision parameter (702). Modifying received text associated with the particular field in dependence upon the text precision parameter is carried out by changing the precision with which numerical text to be displayed is represented. Modifying numerical text to reduce the precision of the numerical text and to reduce the width of the text may be carried out by deleting digits in a number, such as, for example, by modifying “3.141592” to “3.14”. Modifying numerical text to reduce the precision of the numerical text and to reduce the width of the text may also be carried out by changing a numerical representation of magnitude to a non-numeric representation of magnitude, such as by changing “12,183” to “12k.” Deleting digits and changing a numerical representation of magnitude to a non-numeric representation of magnitude are for explanation and not for limitation. In fact, there are many ways of modifying text associated with the particular field for representation with less precision and all such ways are well within the scope of the present invention.

In the method of FIG. 8, visually presenting (318) the display text (326) in the display fields includes visually presenting (708) the modified text (706) in the particular field. Visually presenting the modified text in the particular field may be carried out by displaying the text in the display fields on visual output devices connected to a computer, such as a monitor, the screen of a PDA or cell phone, or other visual output devices as will occur to those of skill in the art. Visually presenting the modified text in the particular field may also be carried out by printing the text in the display fields, writing the text in the display fields to a static digital media or any other way of visually presenting the text in the display fields that will occur to those of skill in the art.

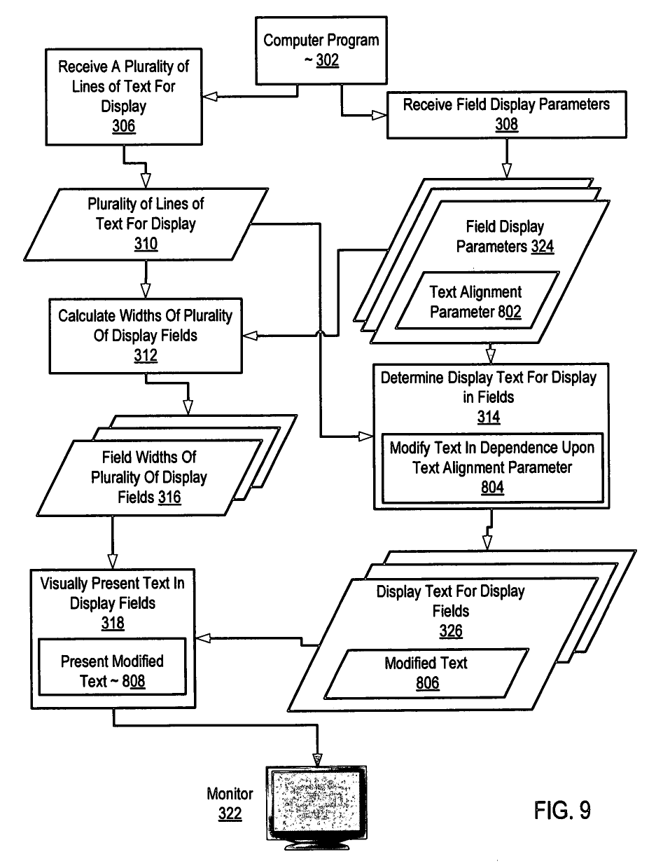

As discussed above, various field display parameters represent different characteristics used for each line of text both to determine the width of a field in which text is to be displayed and whether the text to be displayed in the field is to be modified. For further explanation, FIG. 9 sets forth a flow chart illustrating the method for displaying text in variable width display fields of FIG. 4 in which a field display parameter is a text alignment parameter (802) for a particular field. A text alignment parameter defines the alignment of the text within a field. Text may be aligned within a filed to be right justified, left justified, centered, or any other alignment that will occur to those of skill in the art.

In the method of FIG. 9, determining (314), for each line of text, text (326) for display in the fields in dependence upon the field display parameters (324) is carried out by modifying (804) the received text in dependence upon the text alignment parameter (802). Modifying (804) the received text in dependence upon the text alignment parameter (802) can be carried out by inserting within the filed white space to the left, to the right, or on both sides of the text for display in a field in accordance with the text alignment parameter for the field. White space is typically implemented as a blank character which contributes to the length of the text for display, but is transparent upon display.

In the method of FIG. 9, visually (318) presenting the display text (326) in the display fields includes visually presenting (808) the modified text (806) in the particular field. Visually presenting the modified text in the particular field may be carried out by displaying the text in the display fields on visual output devices connected to a computer, such as a monitor, the screen of a PDA or cell phone, or other visual output devices as will occur to those of skill in the art. Visually presenting the modified text in the particular field may also be carried out by printing the text in the display fields, writing the text in the display fields to a static digital media or any other way of visually presenting the text in the display fields that will occur to those of skill in the art.

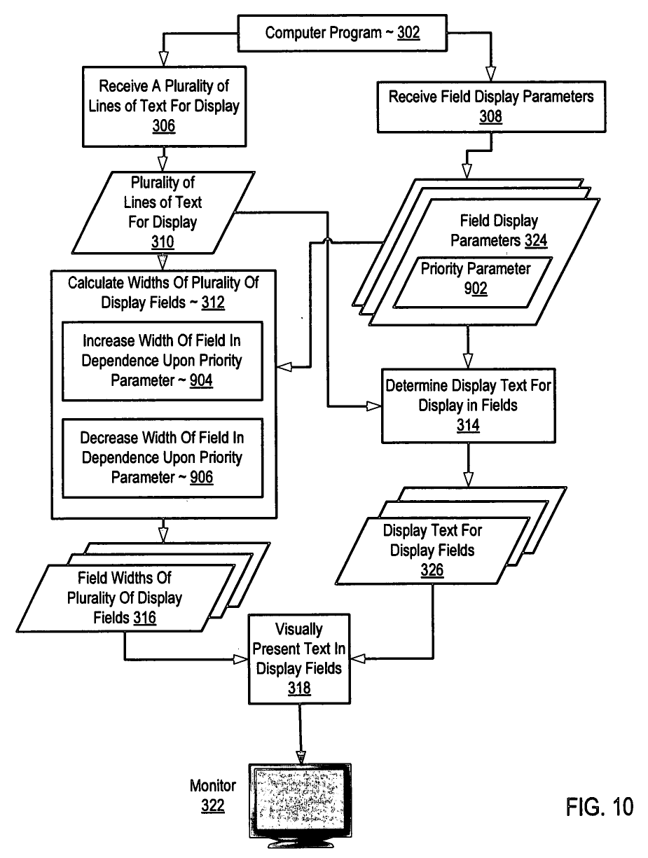

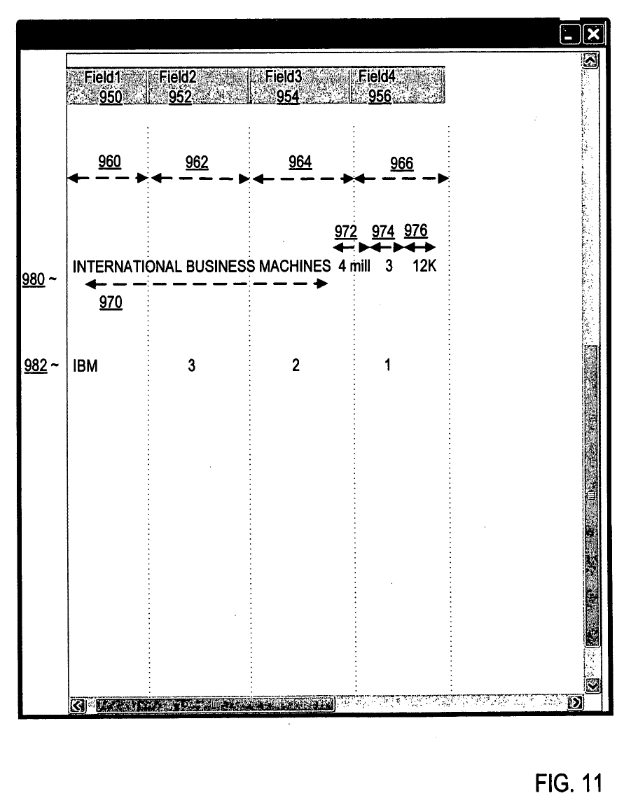

As discussed above, various field display parameters represent different characteristics used for each line of text both to determine the width of a field in which text is to be displayed and whether the text to be displayed in the field is to be modified. For further explanation, FIG. 10 sets forth a flow chart illustrating the method for displaying text in variable width display fields of FIG. 4 in which a field display parameter a priority parameter (902) for a particular field. A priority parameter is a parameter providing an indication of importance of the text to be displayed in a particular field. Typically, important text for display may be assigned a high priority and less important text may be assigned a lower priority. Priorities are useful in determining whether to increase the width of a particular field for displaying the text.

In the method of FIG. 10, calculating (312), for each line of text, the width (316) of a plurality of display fields in dependence upon the field display parameters (324) and the received text (310) includes increasing (904) the width of the particular field in dependence upon the priority parameter (902) and the text (310) and decreasing (906) the width of the particular field in dependence upon the priority parameter (902) and the text (310). As discussed above, priorities are useful in determining whether to increase the width of a particular field for displaying the text. The widths of high priority fields may be increased to accommodate all or most of the text for display in those fields and the width of low priority fields may be decreased to allow for the increase of higher priority fields.

For further explanation, FIG. 11 sets forth a line drawing illustrating an exemplary display having two lines of text (980 and 982) displayed according to the present invention. The exemplary display provides four fields for displaying text each having a default field width. Field 1 (950) has a default field width (960). Field 2 (952) has a default field width (962). Field 3 (954) has a default field width (964). Field 4 (956) has a default field width (966).

In the example of FIG. 11, the two lines of text are generated for display in accordance with the present invention. In the example of FIG. 11, the first line of text (980) is displayed in ‘Field1’ (950), ‘Field2’ (952), ‘Field3’ (954), and ‘Field4’ (956). In the first line of text (980) “INTERNATIONAL BUSINESS MACHINES” is text received for display in Field 1 (950), “4 million” is text received for display in Field 2 (952), “3” is received text for display in Field 3 (954), and “12,183” is text received for display in Field 4 (956). The text received for display in the first line of text (980) is displayed according to the following field display parameters:

<hard boundary ID=1> <9 char, transform=abbreviate, priority=high>
<soft boundary, ID=1, width=1> <12 char, transform=truncate,
priority=low> <soft boundary, ID=2, width=1> <12 char, priority=high>
<soft boundary, ID=3, width=1> <11 char, priority=low,
transform=multipliers><hard boundary ID=2>

The exemplary field display parameters contain the elements ‘<hard boundary>’ and ‘<soft boundary, width=1>’ which indicate a boundaries that define the exemplary fields ‘Field1’ (950), ‘Field2’ (952), ‘Field3’ (954), and ‘Field4’ (956). A hard boundary designates a boundary of field that is static. Hard boundary is not shifted to increase or decrease the width of a particular field. A soft boundary is a boundary that may be shifted to increase or decrease the width of a particular field. ‘Field1’ (950) resides between the hard boundary defined by the field display parameter <hard boundary ID=1> and the soft boundary defined by the field display parameter <soft boundary, ID=1, width=1>.‘Field2’ (952) resides between the soft boundary defined by the field display parameter <soft boundary, ID=1, width=1> and the soft boundary defined by the field display parameter <soft boundary, ID=2, width=1>. ‘Field3’ (954) resides between the soft boundary defined by the field display parameter <soft boundary, ID=2, width=1> and the soft boundary defined by the field display parameter <soft boundary, ID=3, width=1>. ‘Field4’ (956) resides between the soft boundary defined by the field display parameter <soft boundary, ID=3, width=1> and the hard boundary defined by the field display parameter <hard boundary ID=2>.

The exemplary field display parameters contain the element ‘<9 char, priority-high>.’ The sub-element ‘9 char’ identifies a default width of Field 1 (950) as 9 characters. The sub-element ‘priority=medium’ indicates that the text for display in Field 1 (950) is assigned a medium priority.

The exemplary field display parameters contain the element ‘<12 char, transform=truncate, priority=low>’. The sub-element ‘12 char’ designates the default width of Field 2 (952) as 12 characters. The sub-element ‘transform=truncate’ identifies that should text of Field 2 (952) be modified for display within the field the text is to be truncated. The sub element priority=high indicates that the text for display in Field 2 (952) is assigned a high priority.

The exemplary field display parameters contain the element ‘<12 char, priority=high>priority=high>’. The sub-element ‘12 char’ designates the default width of Field 3 (954) as 12 characters. The sub element priority=high indicates that the text for display in Field 3 (954) is assigned a high priority.

The exemplary field display parameters contain the element ‘<11 char, priority=low, transform=non-numerical_representation, align=center>’. The sub-element ‘11 char’ designates the default width of Field 4 (956) as 11 characters. The sub-element ‘transform=non-numerical_representation’ identifies that should numerical text of Field 4 (956) be modified for display within the field, the precision of the numerical text is to be reduced by replacing a numerical representation of magnitude with a non-numerical representation of magnitude. The sub element priority=low indicates that the text for display in Field 4 (956) is assigned a low priority.

As discussed above, the example of FIG. 11 illustrates in the first line of text (980) a display of the text “INTERNATIONAL BUSINESS MACHINES” in Field 1 (950), “4 million” in Field 2 (952), “3” in Field 3 (954), and “12,183” in Field 4 (956) according to the exemplary field display parameters: In Field 1, the length of the text “INTERNATIONAL BUSINESS MACHINES” is greater than the default field width (960) for Field 1. Field 1 (950) is designated by the field display parameters as the only high priority field. The width of Field 1 (954) is therefore calculated by increasing the filed width (970) to 31 characters such that the text may be fully displayed in Field 1.

In the first line of text (980) of the example of FIG. 11, as a result of expanding the width (970) of Field 1 (950), the width (972) of Field 2 (952), the width (974) of Field 3 (954), and the width (976) of Field 4 (956) are calculated by reducing their default widths (962, 964, and 966). Display the text “4 million” generated for display in Field 2 (952) in the reduced width of the field, the text is truncated according to the field display parameters to “4 mill” and the text displayed in the reduced width (972) of Field 2 is “4 mill.” To display the text “3” generated for display in Field 3 (954) in the reduced width (974) of Field 3, no modification of the text is required and the text displayed in reduced width Field 2 is “3.” To display the text “12,183” generated for display in Field 4 (956) in the reduced width (976) of Field 4, the text is modified such that the magnitude of the number is represented in non-numeric form. The modified text, “12K” is then displayed in Field 4 (956).

In the example of FIG. 11, a second line of text (982) including the following text “IBM, 3,2,1” for display in Field 1 (950), Field 2 (952), Field 3 (954), and Field 4 (956) is displayed according to the field display parameters above. The second line of text (982) in the example of FIG. 11 is displayed without modification.

The example of FIG. 11 is included for explanation and not for limitation. Displaying text in variable width display fields by receiving text for display produced by a computer program, receiving field display parameters, calculating the width of a plurality of display fields in dependence upon the field display parameters and the text, determining text for display in the fields in dependence upon the field display parameters, and visually presenting the text in the display fields may be carried out according to many different kinds of display parameters as will occur to those of skill in the art.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for displaying text in variable width display fields, the method comprising:
receiving a plurality of lines of text for display in variable width display fields produced by a computer program;
receiving field display parameters;
calculating, for each line of text, the width of a plurality of display fields in dependence upon the field display parameters and the received text;
determining, for each line of text, display text for display in the display fields in dependence upon the field display parameters and the received text; and
visually presenting the display text in the display fields.

2. The method of claim 1 wherein:
the field display parameters further comprise a text abbreviation parameter for a particular field; and
determining, for each line of text, display text for display in the display fields in dependence upon the field display parameters and the received text further comprises modifying text associated with the particular field in dependence upon the text abbreviation parameter; and
visually presenting the display text in the display fields further comprises visually presenting the modified text in the particular field.

3. The method of claim 1 wherein:
the field display parameters further comprise a total line length parameter for a plurality of display fields; and
calculating, for each line of text, the width of a plurality of display fields in dependence upon the field display parameters and the received text further comprises reducing the width of at least one field in dependence upon the total line length parameter.

4. The method of claim 1 wherein:
the field display parameters further comprise a soft boundary parameter for a boundary between two display fields; and
calculating, for each line of text, the width of a plurality of display fields in dependence upon the field display parameters and the received text further comprises increasing the width of at least one of the two display fields in dependence upon the text to be displayed in the two display fields.

5. The method of claim 1 wherein:
the field display parameters further comprise a text precision parameter for a particular field; and
determining, for each line of text, display text for display in the display fields in dependence upon the field display parameters further comprises modifying received text associated with the particular field in dependence upon the text precision parameter; and
visually presenting the display text in the display fields further comprises visually presenting the modified text in the particular field.

6. The method of claim 1 wherein:
the field display parameters further comprise a text alignment parameter for a particular field;
determining, for each line of text, display text for display in the display fields in dependence upon the field display parameters further comprises modifying the received text in dependence upon the text alignment parameter; and
visually presenting the display text in the display fields further comprises visually presenting the modified received text in the particular field.

7. The method of claim 1 wherein:
the field display parameters further comprise a priority parameter for a particular field; and
calculating, for each line of text, the width of a plurality of display fields in dependence upon the field display parameters and the received text further comprises increasing the width of the particular field in dependence upon the priority parameter and the text.

8. The method of claim 1 wherein:
the field display parameters further comprise a priority parameter for a particular field; and
calculating, for each line of text, the width of a plurality of display fields in dependence upon the field display parameters and the received text further comprises decreasing the width of the particular field in dependence upon the priority parameter and the text.

9. A system for displaying text in variable width display fields, the system comprising:
means for receiving a plurality of lines of text for display in variable width display fields produced by a computer program;
means for receiving field display parameters;
means for calculating, for each line of text, the width of a plurality of display fields in dependence upon the field display parameters and the received text;
means for determining, for each line of text, display text for display in the display fields in dependence upon the field display parameters and the received text; and
means for visually presenting the display text in the display fields.

10. The system of claim 9 wherein:
the field display parameters further comprise a text abbreviation parameter for a particular field; and
means for determining, for each line of text, display text for display in the display fields in dependence upon the field display parameters and the received text further comprises means for modifying text associated with the particular field in dependence upon the text abbreviation parameter; and
means for visually presenting the display text in the display fields further comprises means for visually presenting the modified text in the particular field.

11. The system of claim 9 wherein:
the field display parameters further comprise a total line length parameter for a plurality of display fields; and
means for calculating, for each line of text, the width of a plurality of display fields in dependence upon the field display parameters and the received text further comprises means for reducing the width of at least one field in dependence upon the total line length parameter.

12. The system of claim 9 wherein:
the field display parameters further comprise a soft boundary parameter for a boundary between two display fields; and
means for calculating, for each line of text, the width of a plurality of display fields in dependence upon the field display parameters and the received text further comprises means for increasing the width of at least one of the two display fields in dependence upon the text to be displayed in the two display fields.

13. The system of claim 9 wherein:
the field display parameters further comprise a text precision parameter for a particular field; and
means for determining, for each line of text, display text for display in the display fields in dependence upon the field display parameters further comprises means for modifying received text associated with the particular field in dependence upon the text precision parameter; and
means for visually presenting the display text in the display fields further comprises means for visually presenting the modified text in the particular field.

14. The system of claim 9 wherein:
the field display parameters further comprise a text alignment parameter for a particular field; and
means for determining, for each line of text, display text for display in the display fields in dependence upon the field display parameters further comprises means for modifying the received text in dependence upon the text alignment parameter; and
means for visually presenting the display text in the display fields further comprises means for visually presenting the modified received text in the particular field.

15. The system of claim 9 wherein:
the field display parameters further comprise a priority parameter for a particular field; and
means for calculating, for each line of text, the width of a plurality of display fields in dependence upon the field display parameters and the received text further comprises means for increasing the width of the particular field in dependence upon the priority parameter and the text.

16. The system of claim 9 wherein:
the field display parameters further comprise a priority parameter for a particular field; and
means for calculating, for each line of text, the width of a plurality of display fields in dependence upon the field display parameters and the received text further comprises means for decreasing the width of the particular field in dependence upon the priority parameter and the text.

17. A computer program product for displaying text in variable width display fields, the computer program product comprising:
a recording medium;
means, recorded on the recording medium, for receiving a plurality of lines of text for display in variable width display fields produced by a computer program;
means, recorded on the recording medium, for receiving field display parameters;
means, recorded on the recording medium, for calculating, for each line of text, the width of a plurality of display fields in dependence upon the field display parameters and the received text;
means, recorded on the recording medium, for determining, for each line of text, display text for display in the display fields in dependence upon the field display parameters and the received text; and
means, recorded on the recording medium, for visually presenting the display text in the display fields.

18. The computer program product of claim 17 wherein:
the field display parameters further comprise a text abbreviation parameter for a particular field;
means, recorded on the recording medium, for determining, for each line of text, display text for display in the display fields in dependence upon the field display parameters and the received text further comprises means, recorded on the recording medium, for modifying text associated with the particular field in dependence upon the text abbreviation parameter; and
means, recorded on the recording medium, for visually presenting the display text in the display fields further comprises means, recorded on the recording medium, for visually presenting the modified text in the particular field.

19. The computer program product of claim 17 wherein:
the field display parameters further comprise a total line length parameter for a plurality of display fields; and
means, recorded on the recording medium, for calculating, for each line of text, the width of a plurality of display fields in dependence upon the field display parameters and the received text further comprises means, recorded on the recording medium, for reducing the width of at least one field in dependence upon the total line length parameter.

20. The computer program product of claim 17 wherein:
the field display parameters further comprise a soft boundary parameter for a boundary between two display fields; and
means, recorded on the recording medium, for calculating, for each line of text, the width of a plurality of display fields in dependence upon the field display parameters and the received text further comprises means, recorded on the recording medium, for increasing the width of at least one of the two display fields in dependence upon the text to be displayed in the two display fields.

21. The computer program product of claim 17 wherein:
the field display parameters further comprise a text precision parameter for a particular field; and
means, recorded on the recording medium, for determining, for each line of text, display text for display in the display fields in dependence upon the field display parameters further comprises means, recorded on the recording medium, for modifying received text associated with the particular field in dependence upon the text precision parameter; and
means, recorded on the recording medium, for visually presenting the display text in the display fields further comprises means, recorded on the recording medium, for visually presenting the modified text in the particular field.

22. The computer program product of claim 17 wherein:
the field display parameters further comprise a text alignment parameter for a particular field; and
means, recorded on the recording medium, for determining, for each line of text, display text for display in the display fields in dependence upon the field display parameters further comprises means, recorded on the recording medium, for modifying the received text in dependence upon the text alignment parameter; and
means, recorded on the recording medium, for visually presenting the display text in the display fields further comprises means, recorded on the recording medium, for visually presenting the modified received text in the particular field.

23. The computer program product of claim 17 wherein:
the field display parameters further comprise a priority parameter for a particular field; and
means, recorded on the recording medium, for calculating, for each line of text, the width of a plurality of display fields in dependence upon the field display parameters and the received text further comprises means, recorded on the recording medium, for increasing the width of the particular field in dependence upon the priority parameter and the text.

24. The computer program product of claim 17 wherein:
the field display parameters further comprise a priority parameter for a particular field; and
means, recorded on the recording medium, for calculating, for each line of text, the width of a plurality of display fields in dependence upon the field display parameters and the received text further comprises means, recorded on the recording medium, for decreasing the width of the particular field in dependence upon the priority parameter and the text.
